(19) United States
(12) Patent Application Publication
(10) Pub. No.: US 2013/0176526 A1
(43) Pub. Date: Jul. 11, 2013

(54) SEMI-RIM THREE DIMENSIONAL GLASSES

(71) Applicant: Chun-Hui HUNG, Tu-Cheng (TW)

(72) Inventor: Chun-Hui HUNG, Tu-Cheng (TW)

(73) Assignee: Hon Hai Precision Industry Co., Ltd., Tu-Cheng (TW)

(21) Appl. No.: 13/559,792

(22) Filed: Jul. 27, 2012

(30) Foreign Application Priority Data
Jan. 5, 2012 (TW) 101100454

(51) Int. Cl. G02C 1/04

(52) U.S. Cl. 351/103

(57) ABSTRACT

A pair of semi-rim 3D glasses has a lens frame, a pair of lenses, a pair of bonding sheet, and a fixing plate. The lens frame has a ridge, a buckle seat positioned in the middle of the ridge, and two arms connected to both end of the ridge. The fixing plate has a buckle element configured for the buckle seat to engage the fixing plate to the lens frame. The lenses are symmetrically bonded to the fixing plate on both sides of the buckle element by the bonding sheet.

### BACKGROUND

1. Technical Field

The disclosure is related to a pair of three dimensional (3D) glasses, and particularly to a pair of semi-rim 3D glasses.

2. Description of Related Art

Watching movies in 3D has become popular. 3D technology relies on the viewer wearing a set of 3D glasses. There are two categories of 3D glasses, active and passive. Active 3D glasses operate independently to perform 3D stereo image effects, such as, dual-display 3D glasses or liquid crystal shutter (LCS) 3D glasses, for example. The LCS 3D glasses alternatively dim the right and then the left lenses in succession so that each of the user's eyes sees a slightly different angle of the same image to create 3D stereoscopic effect. On the other hand, passive 3D glasses, such as polarized 3D glasses, create the illusion of three-dimensional images by restricting the light that reaches each eye, stereoscopy exploits the polarization of light, for example. To present a stereoscopic motion picture, two projected images are superimposed onto the same screen through different polarizing filters. The viewer wears low-cost glasses which contain a pair of different polarizing filters. Each filter passes only light which is similarly polarized and blocks the light polarized in the opposite direction, each eye sees a different image to create 3D stereoscopic effect.

The shutters or the polarizing filters are enclosed by rims and are fixed to current 3D glasses. There are problems with today's 3D glasses constructed with temple-pieces and rims can result in a viewing experience that is not entirely pleasurable. Rims hinder user's peripheral vision and restrict appearance of 3D glasses. Besides, rims made of metal are endurable but increase the total weight of current 3D glasses. Manufacturers of 3D glasses have attempted to improve the structure in an attempt to increase the comfort of users.

### BRIEF DESCRIPTION OF THE DRAWINGS

The components in the drawings are not necessarily drawn to scale, the emphasis instead being placed upon clearly illustrating the principles of a semi-rim 3D glasses. Moreover, in the drawings, like reference numerals designate corresponding parts throughout the several views.

FIG. 1 is an exploded perspective view of a pair of semi-rim 3D glasses of the disclosure.

FIG. 2 is a schematic diagram illustrating assembly of the lenses and the fixing plate.

FIG. 3 is a schematic diagram illustrating the semi-rim 3D glasses.

### DETAILED DESCRIPTION

The disclosure will be described with references to the accompanying diagrams.

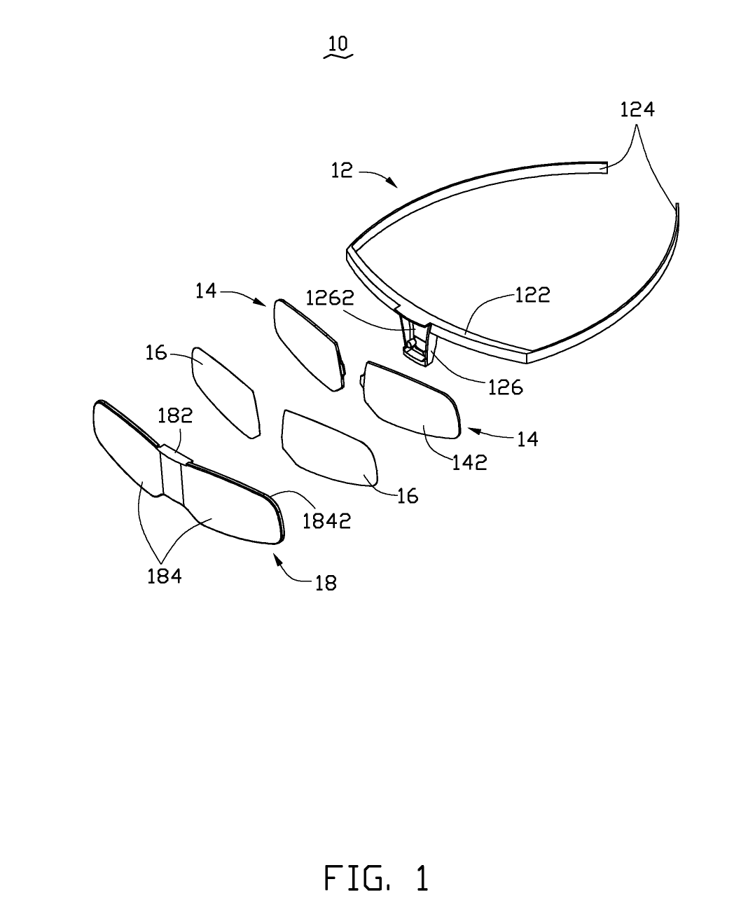

FIG. 1 shows a pair of semi-rim 3D glasses 10 of the disclosure. The semi-rim 3D glasses 10 includes a lens frame 12, a pair of lenses 14, a pair of bonding sheets 16, and a fixing plate 18.

The lens frame 12 has a ridge 122 and two arms 124 symmetrically connected to both end of the ridge 122. The arms 124 hang on a user's ears allowing the lenses 14 to be positioned in front of the user's face. The lens frame 12 further has a buckle seat 126 located in the middle of the ridge 122. The buckle seat 126 has an interior space 1262 for placement of the semi-rim 3D glasses 10. For example, if the semi-rim 3D glasses 10 of the embodiment are active 3D glasses, an electronic apparatus (such as circuit board, battery, and control unit) may be placed in the interior space 1262 and be connected to the lenses 14.

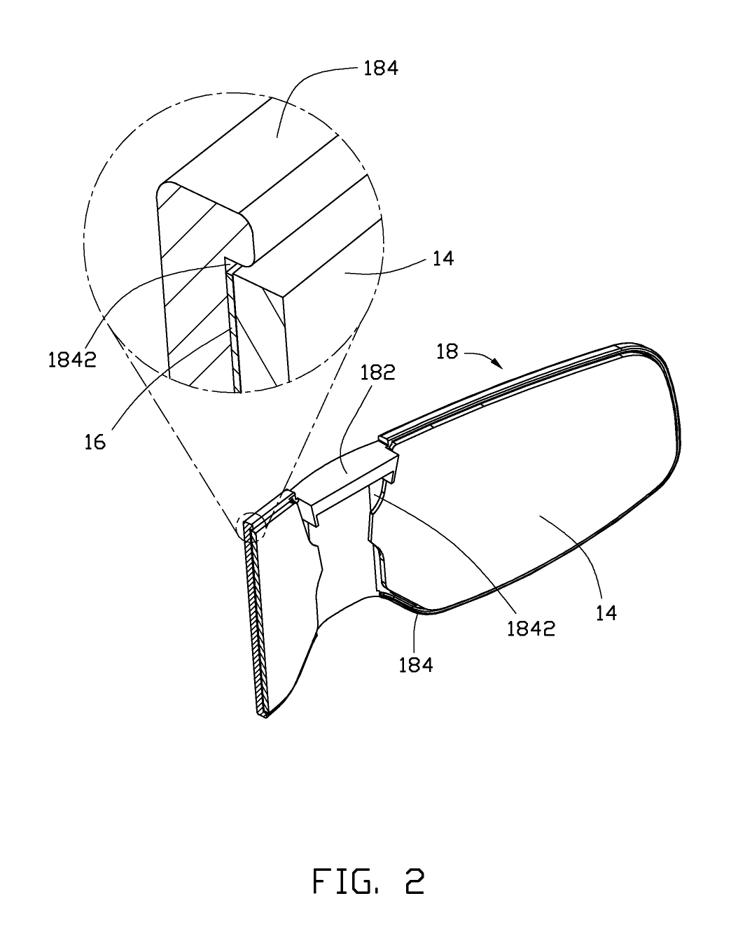

The fixing plate 18 includes a buckle element 182 and two attachment regions 184 defined at both sides of the buckle element 182. The fixing plates 18 are made of plastic material and are transparent. Each attachment region 184 has an inner surface 1842 configured for holding the lenses 14. Each lens 14 has an attachment surface 142 facing the inner surface 1842. The lenses 14 are bonded to the inner surfaces 1842 of the attachment regions 184 by the bonding sheets 16 (see FIG. 2). The bonding sheets 16 are thin and transparent. The shape of the bonding sheet 16 and that of the corresponding lens 14 are identical. The bonding sheet 16 is positioned between the attachment surface 142 of the lens 14 and the inner surface 1842 of the attachment region 184. Therefore, the lenses 14 are symmetrically attached to the fixing plate 18. The inner surface 1842 of the attachment region 184 has a curvature equal to the curvature of the attachment surface 142 of the lenses 14, matching the attachment between the lenses 14 and the fixing plate 18. The shape or the size of the bonding sheets 16 and the lenses 14 may be modified to be stylish and comfortable for the users.

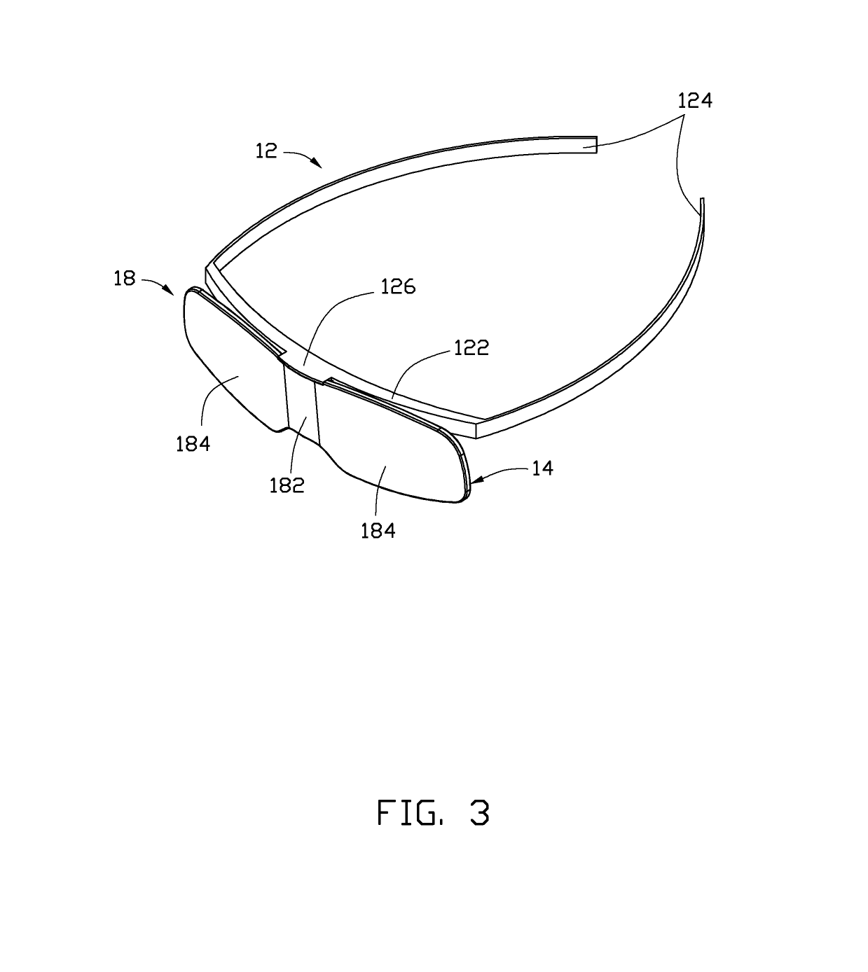

The fixing plate 18 and the lens frame 12 are fixed to each other by engagement between the buckle seat 126 of the lens frame 12 and the buckle element 182 of the fixing plate 18 (see FIG. 3). The buckle element 182 is locked tightly to the buckle seat 126 and adjacent to the ridge 122. The fixing plate 18 and the lens frame 12 may be fixed by screwing or clipping. Since the fixing plate 18 is attached to the lens frame 12, the lenses 14 are held indirectly on the lens frame 12 without the rims. Therefore, the vision of the users wearing the semi-rim 3D glasses 10 is unimpaired without the obstacle of rims. Since the lenses 14 are held without rims, the total weight of the semi-rim 3D glasses 10 is reduced. When a user wears the 3D glasses, the engaged buckle seat 126 and the buckle element 182 are positioned on the user's nose and the lenses 14 are placed in front of user's eyes. Stereoscopic images are switched alternatively or filtered by the lenses 14 to simulate a 3D display for the user. Thus, the semi-rim 3D glasses 10 of the disclosure provides stereoscopic image, user comfort, ease of use, and lower construction cost.

Although the present disclosure has been specifically described on the basis of this exemplary embodiment, the disclosure is not to he construed as being limited thereto. Various changes or modifications may be made to the embodiment without departing from the scope and spirit of the disclosure.

What is claimed is:

1. A pair of semi-rim 3D glasses, comprising:
a lens frame comprising:
a ridge;
two arms connected to both end of the ridge; and
a buckle base located in the middle of the ridge;
a fixing plate having a buckle element engaged to the buckle base; and
a pair of lenses symmetrically attached to the fixing plate by a pair of bonding sheets.

2. The semi-rim 3D glasses of claim 1, wherein the buckle base comprising an interior space.

3. The semi-rim 3D glasses of claim 1, wherein the fixing plate comprises a pair of attachment region on both side of the buckle element.

4. The semi-rim 3D glasses of claim 3, wherein each attachment region has an inner surface for attaching the lens.

5. The semi-rim 3D glasses of claim 4, wherein each lens has an attachment surface facing the inner surface of the attachment region, and the attachment surface has a curvature equal to that of the inner surface.

6. The semi-rim 3D glasses of claim 5, wherein each bonding sheet is positioned between the attachment surface of the lens and the inner surface of the attachment region.

7. The semi-rim 3D glasses of claim 6, wherein the bonding sheet has a shape same as the lens.

8. The semi-rim 3D glasses of claim 1, wherein the fixing plate is made of plastic materials.
